(19) United States
(12) Patent Application Publication
(10) Pub. No.: US 2015/0127358 A1
(43) Pub. Date: May 7, 2015

(54) CARE TRACKER

(71) Applicant: athenahealth, Inc., Watertown, MA (US)

(72) Inventors: Jonathan Porter, Manchester, MA (US); Stephen Porter, Austin, TX (US)

(73) Assignee: athenahealth, Inc., Watertown, MA (US)

(21) Appl. No.: 14/072,068

(22) Filed: Nov. 5, 2013

(51) Int. Cl. G06F 19/00

(52) U.S. Cl. CPC G06F 19/3425
USPC 705/2

(57) ABSTRACT

Methods and apparatus for facilitating coordination of care. A method of transmitting care coordination data to a healthcare provider associated with a patient based, at least in part, on a proximity of the patient to a healthcare facility may involve determining, with at least one processor, whether the proximity of the patient to the healthcare facility satisfies a criterion. The method may further involve transmitting the care coordination data to the healthcare provider associated with the patient after it is determined that the proximity of the patient to the healthcare facility satisfies the criterion.

### BACKGROUND

Medical testing, treatment, or other forms of healthcare may be administered to a patient by a large number of healthcare providers, such as primary-care physicians, specialists in trauma or emergency care, surgeons, or oncologists. In many cases, healthcare providers which administer healthcare to the same patient share little or no health information relating to the patient with each other. Consequently, a healthcare provider may perform costly testing on a patient to diagnose (or rule out) a condition that has already been diagnosed (or ruled out) by another healthcare provider. In some cases, the failure to share patient information may lead a healthcare provider to misdiagnose a patient's condition, or to prescribe an ineffective course of treatment for a patient.

Some healthcare providers use a “practice management system” (“PM system”) to manage health information relating to a healthcare provider's patients. The practice management system may store health information relating to the healthcare provider's patients, and may make the stored health information available to the healthcare provider through a network-based computer system to facilitate patient care.

### SUMMARY

Some embodiments are directed to a method of transmitting care coordination data to a healthcare provider associated with a patient based, at least in part, on a proximity of the patient to a healthcare facility. The method comprises determining, with at least one processor, whether the proximity of the patient to the healthcare facility satisfies a criterion, and after it is determined that the proximity of the patient to the healthcare facility satisfies the criterion, transmitting the care coordination data to the healthcare provider associated with the patient.

Some embodiments are directed to a computer system including at least one server computer configured to host a practice management system, the practice management system comprising at least one processor programmed to determine whether a proximity of a patient to a healthcare facility satisfies a criterion, and control a communications interface to transmit care coordination data to a healthcare provider associated with the patient, after it is determined that the proximity of the patient to the healthcare facility satisfies the criterion.

Some embodiments are directed to at least one computer-readable medium encoded with a plurality of instructions that, when executed by a computer, cause the computer to perform a method of transmitting care coordination data to a healthcare provider associated with a patient based, at least in part, on a proximity of the patient to a healthcare facility. The method comprises determining, with at least one processor, whether the proximity of the patient to the healthcare facility satisfies a criterion, and after it is determined that the proximity of the patient to the healthcare facility satisfies the criterion, transmitting the care coordination data to the healthcare provider associated with the patient.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic of an illustrative practice management system that may be used in accordance with some embodiments;

FIG. 2 is a schematic of an illustrative networked computer system that may be used in accordance with some embodiments;

FIG. 3 is a block diagram of an illustrative care coordination component that may be used in accordance with some embodiments;

FIGS. 4A and 4B are schematics of illustrative portions of a user interface for a practice management system, in accordance with some embodiments;

FIG. 5 is a flowchart of an illustrative process for transmitting care coordination data to a healthcare provider associated with a patient based, at least in part, on a proximity of the patient to a healthcare facility, in accordance with some embodiments;

FIGS. 6A and 6B are flowcharts of illustrative processes for determining whether the proximity of a patient to a healthcare facility satisfies a care coordination criterion, in accordance with some embodiments;

FIGS. 7A, 7B, and 7C are flowcharts of illustrative processes for transmitting a location of a healthcare facility to a computing device associated with a patient, in accordance with some embodiments;

FIG. 8 is a flowchart of an illustrative process for assigning temporary patient identifiers to a patient, in accordance with some embodiments; and

FIG. 9 is a schematic of an illustrative computing device in which some embodiments may be employed.

### DETAILED DESCRIPTION

The present disclosure generally relates to inventive methods and apparatus for facilitating, among healthcare providers, a coordination of care for a patient, and more specifically relates to determining, based, at least in part, on a patient's proximity to a healthcare facility, whether to transmit information to one or more healthcare providers associated with the patient.

In many countries, the cost of healthcare has risen steadily in recent years. In the United States, the rapid rise in the cost of healthcare has significantly strained not only the finances of many individuals and families, but also the finances of many businesses (many of which provide health insurance benefits to their current or retired employees), local and state governments, and the federal government.

Improving the coordination of care for patients may reduce the cost of healthcare and/or improve patient outcomes. Facilitating care coordination in contexts where the need for care coordination arises frequently and/or the costs of failing to coordinate care are high, may be useful in lowering healthcare costs. For example, an unnecessary admission of a patient to a hospital's emergency department or a patient's failure to show up for a scheduled appointment with a healthcare provider may lead to unnecessary healthcare costs (e.g., if unnecessary tests are performed to diagnose or rule out conditions that have already been diagnosed or ruled out by another healthcare provider, or if an untreated ailment is allowed to progress to a more serious state), and may sometimes be avoided by coordinating care. The inventors have recognized and appreciated that cost-effective coordination of care may be facilitated by using an automated system to determine, based, at least in part, on a patient's proximity to a healthcare facility, whether to initiate an act of care coordination. An act of care coordination may include, but is not limited to, the disclosure (e.g., by transmission) of information relating to a patient to a healthcare provider associated with the patient.

As used herein, “health information” may include, but is not limited to, medical records; lab results; imaging results; demographic information; or information relating to diagnoses, treatments, treatment plans, medications, therapies, medical histories, or medical conditions.

As used herein, “healthcare provider” may include, but is not limited to, any person, entity, or computer system that participates in, supervises, or otherwise facilitates the provision of healthcare to a patient. Examples of people who may be healthcare providers include, but are not limited to, healthcare professionals (e.g., physicians, nurses, pharmacists, technicians, or personnel of an entity that is a healthcare provider), acquaintances of the patient (e.g., family members of the patient, friends of the patient, or persons designated as a patient's emergency contacts), caregivers (any person who cares for the patient's health in any way including, but not limited to, a person who lives with the patient, visits the patient, or assists the patient with transportation to or from a healthcare facility). Examples of entities that may be healthcare providers include, but are not limited to, hospitals, medical practices, or health insurance companies. Examples of computer systems that may be healthcare providers include, but are not limited to, practice management systems and computer systems operated by entities or people who are healthcare providers.

As used herein, “care coordination data” may include, but is not limited to, health information relating to a patient or any other information that facilitates or is otherwise relevant to coordination of care for the patient including, but not limited to, the patient's name, location, or proximity to a healthcare facility; information relating to the patient's health insurance; a message regarding the patient; a criterion satisfied by the patient's proximity to a healthcare facility; or information describing a healthcare facility or healthcare provider (e.g., contact information, location information, or identification information for a healthcare facility or healthcare provider).

As used herein, “healthcare facility” may include, but is not limited to, a structure or place where healthcare services are administered (e.g., a hospital building, the office of a medical practice, or a vehicle such as an ambulance or helicopter), or equipment for administering healthcare services.

Embodiments of a Practice Management System

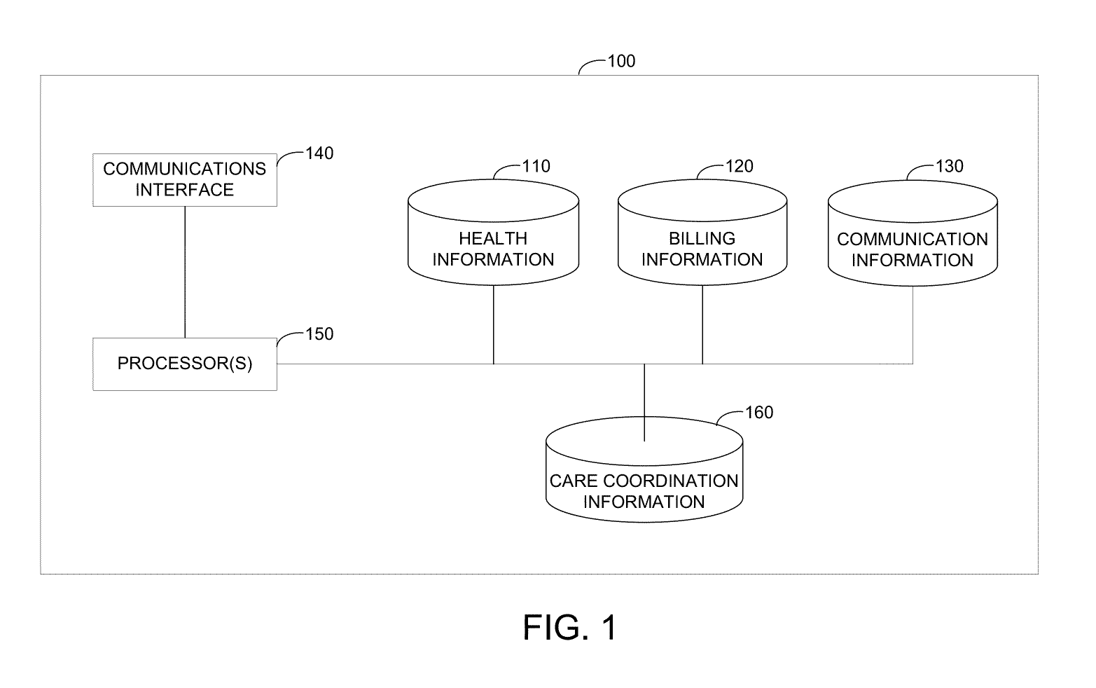

FIG. 1 shows an illustrative practice management system that may be used in accordance with some embodiments. Practice management system (“PM system”) 100 includes a plurality of components configured to perform tasks related to specific functions within the practice management system. In some embodiments, the components may be networked. The components may be configured to facilitate the management of various aspects of medical practices including billing, managing health information, communicating with patients, or coordinating care.

Practice management system 100 includes health information component 110, which may be configured to store health information for patients of medical practices associated with the practice management system. One or more processors 150 of practice management system 100 may be programmed to manage the health information stored by health information component 110. For example, one or more processors 150 may be programmed to provide authorized patients or practices with secure access to at least some health information via communications interface 140.

Practice management system 100 also includes billing information component 120, which may be configured to facilitate the collection, submission, or tracking of claims filed by medical practices associated with the practice management system to a plurality of payers (including, but not limited to, patients). By facilitating interactions between medical practices and payers, billing information component 120 may ensure that the medical practices are properly compensated for the medical services they render to patients.

Practice management system 100 also includes communication information component 130, which may be configured to interact with health information component 110 and billing information component 120, to facilitate interactions with patients on behalf of a medical practice using a communications channel. Communications sent via the communications channel may include, but are not limited to, text-based communications, Internet-based (e.g., web-based) communications, and phone-based communications. In some embodiments, communication information component 130 may include an Internet-based (e.g., web-based) portal implemented as a portion of an Internet application (e.g., web application), with which patients of a medical practice may interact to perform a plurality of actions associated with services at the medical practice including, but not limited to, registering to be a new patient at the medical practice, providing a third party with access to interact with the medical practice, secure messaging of protected health information (PHI) with authorized medical personnel, submitting electronic payment information for medical bills, retrieving laboratory results, accessing educational content, completing medical forms, and receiving directions to the medical practice.

Practice management system 100 also includes care coordination component 160, which may be configured to interact with health information component 110 and/or communication information component 130 to facilitate coordination of care for a patient. Care coordination component 160 may be configured to determine whether a patient's proximity to a healthcare facility satisfies one or more criteria for transmitting care coordination data to a healthcare provider associated with a patient. Such criteria may be referred to as a “care coordination criteria.” Suitable care coordination criteria may include, but are not limited to, (1) the proximity of the patient to the healthcare facility being less than a threshold proximity, or (2) the patient being late (or practice management system 100 predicting that the patient is likely to be late) for a scheduled appointment at the healthcare facility.

Upon determining that the patient's proximity to the healthcare facility satisfies one or more care coordination criteria, care coordination component 160 may transmit care coordination data to one or more healthcare providers associated with the patient. By transmitting the care coordination data to the healthcare provider(s), the coordination of care for the patient may be facilitated. In some embodiments, the healthcare provider to which care coordination component 160 transmits the care coordination data may be a friend or relative of the patient.

For example, if the patient's proximity to an emergency care facility (e.g., a hospital with an emergency department) is less than a threshold proximity, care coordination component 160 may transmit a message to a friend or relative of the patient (e.g., a friend or relative designated by the patient as an emergency contact), indicating that the patient is believed to be in or near the emergency care facility, and requesting that the recipient of the message contact the patient or a healthcare provider associated with the emergency care facility to facilitate coordination of care for the patient. As an alternative to or in addition to transmitting such a message, care coordination component 160 may transmit health information relating to the patient to a healthcare provider associated with the emergency care facility to facilitate coordination of care for the patient.

By facilitating care coordination as in the foregoing example, practice management system 100 may reduce unnecessary healthcare costs that arise when elderly or chronically ill patients make unscheduled visits to emergency care facilities. When an elderly or chronically ill patient visits an emergency care facility seeking medical treatment, the underlying cause of the patient's complaint may be a chronic illness or condition that the patient's primary care physician has diagnosed and/or is treating. However, without the benefit of the medical records maintained by the primary care physician, a healthcare provider associated with the emergency care facility (e.g., a physician who works in the facility's emergency department) may admit the patient for monitoring and testing, to rule out the existence of a severe illness or injury requiring emergency intervention. Such diagnostic testing and monitoring may be very expensive, and in cases where the patient's condition has already been diagnosed by the patient's primary care physician, partially or wholly unnecessary. Thus, facilitating coordination of care in such cases may reduce unnecessary healthcare costs.

As another example, if the practice management system determines that the patient is late (or is likely to be late) for a scheduled appointment at a healthcare facility (e.g., based on the patient's proximity to the healthcare facility at the time of the appointment or at a time before the appointment), care coordination component 160 may transmit a message to a friend or relative of the patient (e.g., a friend or relative designated by the patient as an emergency contact), indicating that the patient is likely to miss the scheduled appointment at the healthcare facility, and requesting that the recipient of the message contact the patient or a healthcare provider associated with the healthcare facility to facilitate coordination of care for the patient. As an alternative to or in addition to transmitting such a message, care coordination component 160 may transmit health information relating to the patient to a healthcare provider associated with the healthcare facility to facilitate coordination of care for the patient.

By facilitating coordination of care as in the foregoing example, practice management system 100 may reduce unnecessary healthcare costs that arise when patients miss scheduled appointments with healthcare providers. When a patient misses a scheduled appointment with a healthcare provider, diagnosis and/or treatment of an illness or injury may be delayed until a time when the illness or injury has progressed to a more severe state. The cost of treating the patient after the illness or injury has progressed to the more severe state may be higher than the cost of treating the patient before the illness or injury progresses. Thus, facilitating coordination of care in such cases may reduce unnecessary healthcare costs.

Practice management system 100 also includes a communications interface 140, which may be configured to communicate via at least one network with one or more sources external to the practice management system. For example, the practice management system 100 may communicate on behalf of a medical practice by sending and/or receiving information to/from other healthcare providers including, but not limited to, pharmacies, laboratories, and payers such as insurance companies. Communications interface 140 may receive communications (e.g., from medical practices, other healthcare providers, or patients) in any suitable format (e.g., fax, email or other electronic transmission) and the techniques described herein are not limited by the particular format in which information is received.

It should be appreciated that practice management system 100 may include any suitable number of components that interact in any suitable way, and the illustrative embodiment shown in FIG. 1 is merely provided to describe one example system. Practice management system 100 may include additional or fewer components than those shown in FIG. 1, as embodiments are not limited in this respect. Furthermore, some or all of the components in practice management system 100 may interact by sharing data, triggering actions to be performed by other components, preventing actions from being performed by other components, storing data on behalf of other components, and/or interacting in any other suitable way.

In some embodiments, communications interface 140 may be included as a portion of one or more of health information component 110, billing information component 120, communication information component 130, or care coordination information component 160, and the techniques described herein are not limited in the particular manner in which each of the components of practice management system 100 is configured send information to or receive information from an external source.

In some embodiments, components of practice management system 100 may be implemented using hardware, software, or a combination thereof. For example, care information component 160 may be implemented as processor-executable instructions that may be executed by one or more processors 150. Processor(s) 150 may be disposed in a single computer or distributed among multiple computers.

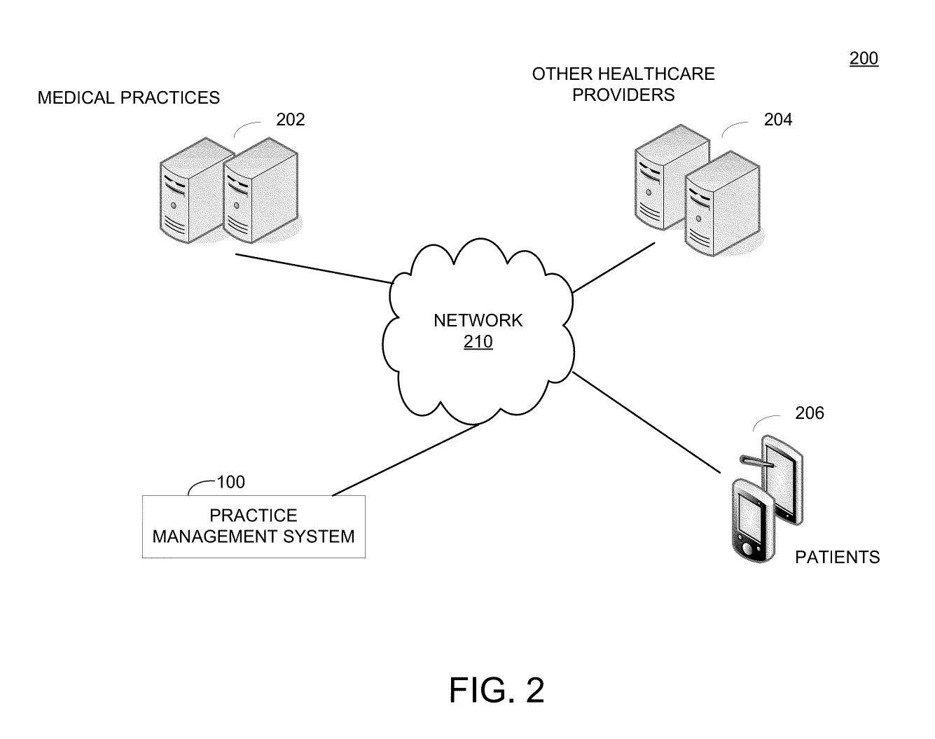

FIG. 2 illustrates an exemplary networked computer system that may be used in accordance with some embodiments. In the computer system of FIG. 2, practice management system 100 is communicatively coupled through network 210 to computing devices 202 associated with one or more medical practices, computing devices 204 associated with one or more other healthcare providers, and computing devices 206 associated with one or more patients. In some embodiments, practice management system 100 may be configured to provide practice management services to the connected medical practices. In some embodiments, practice management system 100 may be configured to provide care coordination services on behalf of the patients or medical practices.

Network 210 may be any type of local or remote network including, for example, a local area network (LAN) or a wide area network (WAN) such as the Internet. It should be appreciated that network 210 may interconnect any number of computers of various types and the specific arrangement of computing devices illustrated in FIG. 2 is provided merely for illustrative purposes. For example, practice management system 100 may be connected via network 210 (or other networks) to a plurality of computing devices of a plurality of healthcare providers (e.g., medical practices and/or other healthcare providers) or patients, to provide practice management services to the connected healthcare providers, or to provide care coordination services on behalf of the patients or healthcare providers. As should be appreciated from the foregoing, some embodiments may be employed in a networked computer system regardless of the network's type, size, or configuration. Additionally, one or more of the computers in the networked system may be protected from unauthorized access using any suitable security protection devices or processes including, but not limited to, firewalls, data encryption, data encoding, and password-protected storage.

In some embodiments, practice management system 100 uses the computer system of FIG. 2 to facilitate care coordination by determining whether a patient's proximity to a healthcare facility satisfies one or more criteria, and by transmitting care coordination data to one or more healthcare providers associated with the patient when it is determined that the patient's proximity to a healthcare facility satisfies the one or more criteria. A patient's proximity to a healthcare facility may be determined in any suitable way. For example, in some embodiments, the patient's proximity to a healthcare facility may be determined based, at least in part, on the patient's location and on the healthcare facility's location.

The patient's location may be determined in any suitable way. For example, the patient may be associated with (e.g., carry) a tracking device which allows a tracking system in communication with the tracking device to monitor the location of the tracking device. As another example, a computing device 206 (e.g., a mobile computing device) of the patient may include a location-sensing component configured to determine the patient's location (or a proxy for the patient's location, such as the location of the computing device, or the location of a wireless access point, relay station, or base station through which the computing device is connected to network 210). A computing device that includes a location-sensing component may use any suitable technique or technology to determine the patient's location including, but not limited to, a positioning system or an inertial navigation system. For example, the device may use a global positioning system (GPS) receiver or some other suitable technique to determine the location of the patient.

Determining a patient's proximity to a healthcare facility may include, but is not limited to, determining a temporal proximity (e.g., an estimate of the amount of time required for the patient to travel from the patient's current location to the location of healthcare facility), a spatial proximity (e.g., a physical distance between the patient's current location and the location of the healthcare facility), or any other suitable metric of proximity. A spatial proximity between the patient's current location and the location of the healthcare facility may include, but is not limited to, a straight-line distance between the two locations, a geodesic distance between the two locations, or a distance between the two locations along a particular route (e.g., a route for foot traffic or a route for automobile traffic).

A patient's spatial proximity to a healthcare facility may be determined by comparing the patient's location and the healthcare facility's location, or by using any other suitable technique. In some embodiments, spatial proximity of the patient to the facility may be determined based, at least in part, on a physical distance between the patient's location and the facility's location. Physical distance between two locations may be determined by any suitable technique including, but not limited to, using coordinates that represent the two locations to calculate the physical distance between the locations, consulting a look-up table of pre-computed or pre-measured distances between locations, querying a mapping service for a distance or a route between the patient's location and the facility's location, using a combination of any of the aforementioned techniques, or using any other suitable technique.

A patient's temporal proximity to a healthcare facility may be determined by obtaining an estimate of the amount of time (“estimated travel time”) that would elapse as the patient traveled from the patient's location to the facility's location, or by using any other suitable technique. An estimate of the amount of time that would elapse as the patient traveled from the patient's location to the facility's location may be obtained using any suitable technique. In some embodiments, the patient's estimated travel time to the facility may be estimated based on one or more items of information including, but not limited to, available routes between the two locations, available methods of traveling (e.g., walking, traveling by private automobile, traveling by airplane, traveling by public transportation, etc.), transportation schedules (e.g., for public transportation), speed limits, traffic patterns, weather patterns, or the patient's current speed. For example, the patient's current speed may be determined by dividing the distance between the patient's last two locations by the difference between the times at which the patient was at those two locations. If the patient's current location is within a few miles of the healthcare facility and the patient's current speed is a walking speed (e.g., 2-4 miles per hour), the estimated travel time may be obtained by determining the length of a walking route from the patient's location to the healthcare facility's location (e.g., by querying a mapping service), and by dividing the length of the route by the patient's current speed.

In some embodiments, determining whether a patient's proximity to a healthcare facility satisfies one or more care coordination criteria comprises determining value(s) of one or more care coordination criteria that depend on the patient's proximity to a healthcare facility. The criteria may be based, at least in part, on the patient's proximity to the health care facility. A first criterion for coordinating care may be whether the patient's proximity to a healthcare facility is less than a threshold proximity (e.g., whether the spatial proximity to the facility is less than 500 meters, less than 200 meters, less than 100 meters, less than 50 meters, less than 10 meters, less than 5 meters, or less than 1 meter). Satisfaction of the first criterion may indicate that the patient is making an unscheduled visit to a healthcare facility. A second criterion for coordinating care may be whether the patient's proximity to the health care facility remains less than a threshold proximity for a threshold period of time (e.g., whether the patient's spatial proximity to the facility remains below a threshold spatial proximity for at least 10 seconds, at least 30 seconds, at least one minute, at least two minutes, at least five minutes, or at least ten minutes). Satisfaction of the second criterion may indicate that the patient is making an unscheduled visit to the healthcare facility and not just passing near the facility. As discussed above, facilitating coordination of care for a patient during the patient's unscheduled visit to a healthcare facility (e.g., an emergency care facility) may reduce healthcare costs.

A third criterion for coordinating care may be whether the patient's proximity to a healthcare facility is greater than a threshold proximity at a time when the patient has a scheduled appointment at the healthcare facility (e.g., whether the patient's spatial proximity to the facility is greater than 1, 5, 10, 50, 100, 200, or 500 meters at the time of the appointment, or whether the patient's temporal proximity from the facility is greater than 1, 2, 5, 10, 15, or 30 minutes at the time of the appointment). Satisfaction of the third criterion may indicate that the patient has missed the appointment or is late for the appointment. A fourth criterion for coordinating care may be whether the patient's proximity to a healthcare facility is greater than a threshold proximity during a specified time period prior to the time of the patient's scheduled appointment at the healthcare facility (e.g., during a time period within 5, 10, 15, 20, 30, or 60 minutes prior to the scheduled time of the appointment). Satisfaction of the fourth criterion may indicate that the patient is likely to miss the appointment or be late for the appointment. A fifth criterion for coordinating care may be whether, during a time period prior to a patient's scheduled appointment at a healthcare facility (e.g., during a time period within 5, 10, 15, 20, 30, or 60 minutes prior to the scheduled time of the appointment), the patient's temporal proximity to a healthcare facility is greater than the amount of time remaining before the scheduled time of the patient's appointment.

Embodiments are not limited to the care coordination criteria described above. Embodiments may use any suitable criterion to determine that a patient is making an unscheduled visit to a healthcare facility, to determine that a patient has missed (or is late for) a scheduled appointment at a healthcare facility, to determine that a patient is likely to miss (or be late for) a scheduled appointment at the healthcare facility, or to determine the existence of any other circumstances under which facilitating coordination of care for the patient may be beneficial.

When it is determined that the patient's proximity to a healthcare facility satisfies one or more care coordination criteria, care coordination may be facilitated by transmitting care coordination data to an entity, such as a healthcare provider, a care coordination facilitator, a computing device associated with the patient, or any other suitable entity. The entity to which the care coordination data is transmitted may be selected in any suitable way. In some embodiments, care coordination component 160 may transmit the care coordination data to a healthcare provider whom the patient has previously designated as a care coordination facilitator. In some embodiments, care coordination component 160 may transmit the care coordination data to a computing device 206 associated with the patient, thereby allowing the patient to facilitate coordination by sharing the care coordination data with a healthcare provider at the healthcare facility visited by the patient, or by using the care coordination data in some other suitable way. In some embodiments, care coordination component 160 may transmit the care coordination data to a healthcare provider at the healthcare facility visited by the patient. Practice management system 100 may store contact information for the computing device 206 associated with the patient and/or for healthcare providers associated with the patient.

Processing and/or data related to the above-described techniques for facilitating care coordination may be distributed among one or more computing devices of a networked computer system in any suitable way. For example, some or all data processing and/or data storage performed by networked computer system 200 to facilitate care coordination may be performed by practice management system 100. Distributing the data processing and/or data storage in this manner may reduce the data processing and/or data storage demands on the computing device 206 associated with the patient, thereby preserving the device's battery life and storage space for other applications. As another example, some or all data processing and/or data storage performed by networked computer system 200 to determine whether a patient's proximity to a healthcare facility satisfies one or more care coordination criteria may be performed by the computing device 206 associated with the patient. Distributing the data processing and/or data storage in this manner may reduce the frequency of communication between the computing device 206 associated with the patient and the practice management system 100.

In some embodiments, a computing device 206 associated with a patient may determine the patient's location and transmit tracking data including the patient's location to practice management system 100. The determining and/or transmitting may be performed periodically (e.g., at regular intervals, at irregular intervals, or at specified times) and/or in response to receiving a transmission from practice management system 100. In response to receiving the tracking data, the PM system may determine whether the patient's proximity to a healthcare facility satisfies one or more care coordination criteria (e.g., by determining the patient's proximity to one or more healthcare facilities, and by determining the value(s) of one or more care coordination criteria based, at least in part, on the determined proximity). In response to determining that the patient's proximity to a healthcare facility satisfies a care coordination criterion, the PM system may perform any action suitable for facilitating care coordination including, but not limited to, transmitting care coordination data to one or more healthcare providers associated with the patient. In such embodiments, the computing device 206 associated with the patient may store little or no data relating to facilitation of care coordination. Such data (e.g., locations of healthcare facilities, data used to determine a patient's proximity to a healthcare facility, data relating to healthcare providers or facilities, care coordination criteria, data used to determine values of care coordination criteria, or care coordination data) may be stored by the PM system.

In some embodiments, a computing device 206 associated with a patient may determine the patient's location and, based, at least in part, on the patient's location, determine the patient's proximity to one or more healthcare facilities. The patient's device 206 may transmit to PM system 100 tracking data including the patient's location and/or proximity to one or more healthcare facilities. The determining and/or transmitting may be performed periodically and/or in response to receiving a transmission from practice management system 100. In response to receiving the tracking data, the PM system may determine whether the patient's proximity to a healthcare facility satisfies one or more care coordination criteria (e.g., by determining value(s) of one or more care coordination criteria based, at least in part, on the determined proximity). In response to determining that the patient's proximity to a healthcare facility satisfies one or more care coordination criteria, the PM system may perform any action suitable for facilitating care coordination including, but not limited to, transmitting care coordination data to one or more healthcare providers associated with the patient. In such embodiments, the computing device 206 associated with the patient may store the locations of the one or more healthcare facilities and any other data used to determine the patient's proximity to a healthcare facility.

In some embodiments, a computing device 206 associated with a patient may determine the patient's location and, based, at least in part, on the patient's location, determine whether the patient's proximity to a healthcare facility satisfies one or more care coordination criteria. After determining that a care coordination criterion is satisfied, the patient's device 206 may transmit tracking data to PM system 100. The tracking data may include a patient identifier (e.g., any suitable data that identifies the patient) and a healthcare facility identifier (e.g., any suitable data that identifies the healthcare facility to which the patient's proximity satisfies one or more care coordination criteria). The determining and/or transmitting may be performed periodically and/or in response to receiving a transmission from practice management system 100. In response to receiving the tracking data, PM system 100 may perform any action suitable for facilitating care coordination including, but not limited to, transmitting care coordination data to one or more healthcare providers associated with the patient. In such embodiments, the computing device 206 associated with the patient may store the locations of the one or more healthcare facilities, the care coordination criteria, and any data used to determine the patient's proximity to a healthcare facility or to determine value(s) of the one or more care coordination criteria.

In some embodiments, a computing device 206 associated with a patient may determine the patient's location and, based, at least in part, on the patient's location, determine the whether the patient's proximity to a healthcare facility satisfies one or more care coordination criteria. After determining that a care coordination criterion is satisfied, the patient's device 206 may perform any action suitable for facilitating care coordination including, but not limited to, transmitting care coordination data to one or more healthcare providers associated with the patient. The determining and/or performing any suitable action may be performed periodically and/or in response to receiving a transmission from practice management system 100. In such embodiments, the computing device 206 associated with the patient may store the locations of the healthcare facilities, the care coordination criteria, any data used to determine the patient's proximity to a healthcare facility or to determine value(s) of the care coordination criteria, and care coordination data.

Irrespective of any data stored by a computing device 206 associated with a patient, practice management system 100 may store any data used to facilitate care coordination including, but not limited to, locations of healthcare facilities, data used to determine a patient's proximity to a healthcare facility, care coordination criteria, data used to determine value(s) of care coordination criteria, data relating to healthcare providers or facilities, or care coordination data.

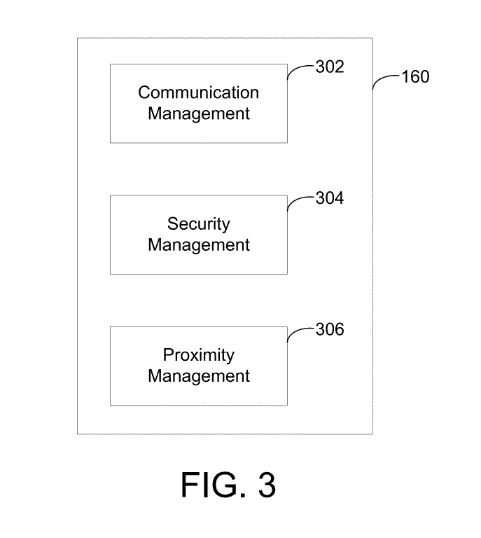

FIG. 3 illustrates a block diagram of a care coordination component 160, according to some embodiments. In some embodiments, care coordination component 160 includes a communication management component 302, which may be configured to interact with communication information component 130 to present a user interface for enrolling patients in a care coordination program and for configuring patients' care coordination preferences. The user interface may be presented, for example, at a computing device associated with a patient or at a computing device associated with a medical practice. The user interface may include, but is not limited to, an Internet (e.g., web) portal, a homepage (e.g., webpage), or any other user interface suitable for communicating with a practice management system via a network such as the Internet.

In some embodiments, the user interface may be used to enroll patients in a care coordination program. As part of the process of enrolling a patient in a care coordination program, a practice management system 100 may store data indicating an association between the patient and a computing device which includes a location-sensing component. The computing device may be a computing device already in the patient's possession (e.g., for personal or business use), the computing device may be supplied to the patient as part of the enrollment process (e.g., by the patient's medical practice or by a suitable third party), or the computing device may be associated with the patient in any other suitable way. Suitable computing devices may include, but are not limited to, tablet computers, smartphones, mobile phones, wearable computers, electronic textiles, personal health monitoring devices, or any other mobile computing devices suitable for determining a patient's location.

In some embodiments, as part of the process of enrolling a patient in a care coordination program, the computing device associated with the patient may be configured to communicate with the practice management system to enable the practice management system to determine whether the patient's proximity to a healthcare facility satisfies one or more criteria for facilitating coordination of care. The patient's device may communicate with the PM system using any suitable communication network including, but not limited to, a cellular phone network and/or the Internet. In some embodiments, configuring the patient's device to communicate with the PM system may include, but is not limited to, loading software onto the patient's device (e.g., downloading an “app” to the patient's device). In some embodiments, the user interface may be presented on the computing device associated with the patient. Some embodiments of the computing device associated with the patient are described in more detail below.

In some embodiments, as part of the process of enrolling a patient in a care coordination program, a patient identifier (patient ID) may be assigned to the patient. In some embodiments, care coordination component 160 may generate the patient ID and send the patient ID to the patient or the patient's medical practice (e.g., via the user interface, using secure email, via the computing device associated with the patient, and/or using any other suitable technique). In some embodiments, the patient ID may be a unique identifier for the patient such as a code generated by a practice management system 100. The patient ID may then be entered into the computing device 206 associated with the patient through any suitable data-entry technique including, but not limited to, typing the patient ID on a keyboard, keypad, or touchscreen, or scanning a representation of the patient ID (such as a bar code or a quick response (“QR”) code). The component used to enter the patient ID into the computing device 206 associated with the patient may be a part of the computing device 206 or communicatively coupled to the computing device 206. In some embodiments, care coordination component 160 may send the patient ID to the computing device 206 associated with the patient. Care coordination component 160 may store data associating the patient with the assigned patient ID. When PM system 100 sends data to or receives data from a computing device 206 associated with a patient, the data may include the patient's patient ID in addition to or rather than including personal information, such as the patient's name, to identify the patient.

As part of the enrollment process, the patient and/or a healthcare provider (such as a representative of the patient's medical practice) may specify the patient's care coordination preferences and send the specified preferences to the PM system. For example, the specified preferences may be entered into the user interface and/or sent to the PM system through a user interface. Specifying the patient's care coordination preferences may include authorizing the PM system to monitor the patient's proximity to one or more identified healthcare facilities (e.g., hospitals or urgent care centers in areas where the patient lives or frequently travels), and/or to monitor the patient's proximity to one or more identified types of healthcare facilities (e.g., emergency care facilities, trauma facilities, urgent care facilities, pharmacies, extended-care facilities, or any other type of healthcare facility).

Specifying the patient's care coordination preferences may include identifying one or more care coordination criteria which, when satisfied (individually or collectively), constitute an authorization for the PM system to facilitate coordination of care for the patient. For example, the patient's care coordination preferences may authorize the PM system to coordinate care for the patient when the PM system determines that the patient's proximity to one of the identified healthcare facilities or types of healthcare facilities is less than a threshold proximity. As another example, the patient's care coordination preferences may authorize the PM system to coordinate care for the patient when the PM system determines that the patient has missed (or is predicted to miss) a scheduled appointment at a healthcare facility.

Specifying the patient's care coordination preferences may include identifying one or more types of care coordination data which may be automatically disclosed by the PM system to one or more healthcare providers associated with the patient when the PM system facilitates coordination of care for the patient. In some embodiments, specifying the patient's care coordination preferences may also include supplying particular care coordination data to the PM system. When facilitating coordination of care for the patient, the PM system may disclose some or all of the identified types of care coordination data using any suitable communication technique including, but not limited to, initiating a telephone call, sending an email, transmitting a fax, sending a text message or SMS, text-based, audio-based, or video-based chat session, or sending a message through social media.

Specifying the patient's care coordination preferences may include identifying one or more healthcare providers to be contacted by the PM system when the PM system facilitates coordination of care for the patient. In some embodiments, identifying the one or more healthcare providers may include providing contact information for the one or more healthcare providers. The contact information may include, but is not limited to, telephone numbers, email addresses, fax numbers, or social media handles. The identified healthcare provider(s) may be authorized by the patient to participate in coordination of care for the patient. The PM system may contact some or all of the identified healthcare provider(s) using any suitable communication technique including, but not limited to, initiating a telephone call, sending an email, transmitting a fax, sending a text message or SMS, initiating a text-based, audio-based, or video-based chat session, or sending a message through social media. In some embodiments, the healthcare provider(s) contacted by the PM system may depend on the care coordination criterion or criteria that are satisfied.

In some embodiments, the patient's care coordination preferences may be modified after enrollment by logging into PM system (e.g., through the user interface) and editing the patient's care coordination profile.

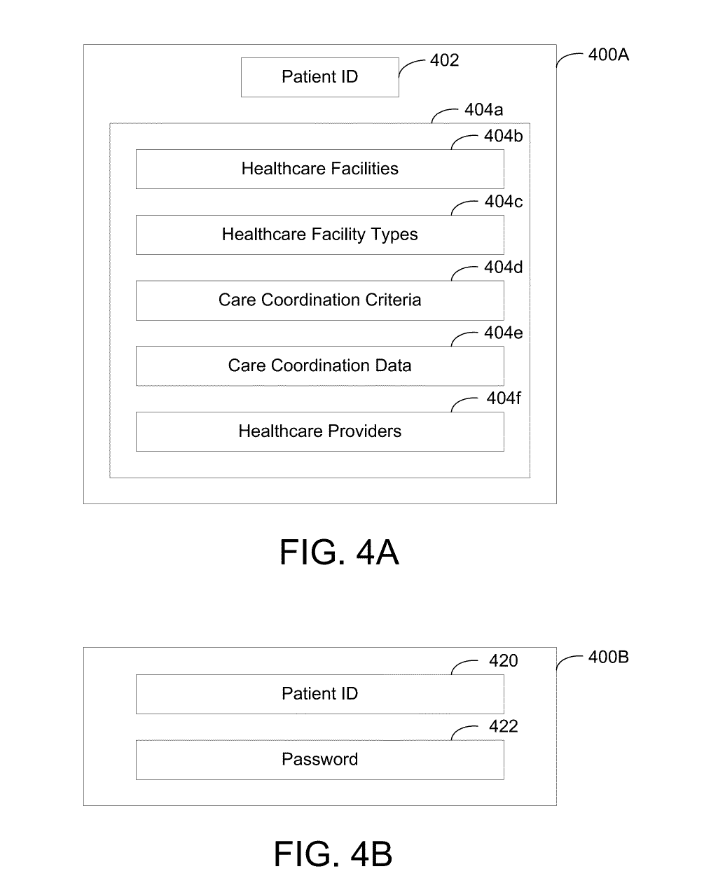

FIG. 4A illustrates a schematic of a portion 400A of a user interface for a practice management system, in accordance with some embodiments. The portion of the user interface illustrated in FIG. 4A may be configured for enrolling a patient in a care coordination program and/or for editing the profile of a patient previously enrolled in a care coordination program. In the example of FIG. 4A, the enrollment/profile portion of the user interface includes a patient ID section 402 and a care coordination preference section 404a. In some embodiments, patient ID section 402 may display a patient ID assigned to a patient by the practice management system. In some embodiments, patient ID section 402 may permit a user to input (e.g., type) a patient ID to be associated with the patient by the practice management system. In some embodiments, the patient ID entered or displayed in patient ID section 402 may be entered or displayed as a string of one or more characters (e.g., alphanumeric characters, symbols, or other characters).

Care coordination preference section 404a may be configured to receive inputs from a user (e.g., patient, physician, representative of a medical practice, or any other suitable user) indicating the care coordination preferences for the patient. In the example of FIG. 4A, care coordination preference section includes five subsections: a healthcare facilities subsection 404b, a healthcare facility types subsection 404c, a care coordination criteria subsection 404d, a care coordination data section 404e, and a healthcare providers section 404f. In some embodiments, default care coordination preferences may be set by the practice management system, by a medical practice associated with the patient, or by any other suitable user or technique. In the absence of receiving input from a user to modify the default care coordination preferences, the default care coordination preferences may be used by practice management system 100 to facilitate coordination of care for the patient. In some embodiments, care coordination preference section 404a may include, but is not limited to, all five subsections illustrated in FIG. 4A, any subset of the five subsections illustrated in FIG. 4A, and/or other subsections not illustrated in FIG. 4A.

In some embodiments, healthcare facilities subsection 404b may be configured to receive input from a user identifying one or more particular healthcare facilities for which the user or the patient authorizes the PM system to facilitate care coordination. Healthcare facilities subsection 404b may receive the user's input via any suitable interface component including, but not limited to, a drop-down dialog, a multi-selection dialog, or a text box.

In some embodiments, healthcare facility types subsection 404c may be configured to receive input from a user identifying one or more types of healthcare facilities for which the user or patient authorizes the PM system to facilitate care coordination. Healthcare facility types subsection 404c may receive the user's input via any suitable interface component including, but not limited to, a drop-down dialog, a multi-selection dialog, or a text box.

In some embodiments, care coordination criteria subsection 404d may be configured to receive input from a user identifying one or more care coordination criteria which, when satisfied (individually or collectively), constitute an authorization for the PM system to facilitate coordination of care for the patient. Care coordination criteria subsection 404d may receive the user's input via any suitable interface component including, but not limited to, a drop-down dialog or a multi-selection dialog.

In some embodiments, care coordination data subsection 404e may be configured to receive input from a user identifying one or more types of care coordination data which may be automatically disclosed by the PM system to one or more healthcare providers associated with the patient when the PM system facilitates coordination of care for the patient. In some embodiments, care coordination data subsection 404e may be configured to receive input from a user specifying care coordination data (e.g., contact information for a person designated as the patient's emergency contact). Care coordination data subsection 404e may receive the user's input via any suitable interface component including, but not limited to, a drop-down dialog, a multi-selection dialog, or a text box.

In some embodiments, healthcare providers subsection 404f may be configured to receive input from a user identifying one or more healthcare providers to be contacted by the PM system when the PM system facilitates coordination of care for the patient. Healthcare providers subsection 404e may receive the user's input via any suitable interface component including, but not limited to, a drop-down dialog, a multi-selection dialog, or a text box.

FIG. 4B illustrates a schematic of another portion 400B of a user interface for a practice management system, in accordance with some embodiments. The portion of the user interface illustrated in FIG. 4B may be configured to receive login information for a patient, determine whether the login information is valid, and, after determining that the login information is valid, direct the user to another portion of the user interface including, but not limited to, a portion of the user interface configured to display the patient's care coordination preferences and/or receive inputs from a user indicating the patient's care coordination preferences. In some embodiments, the user may be directed to the portion of the user interface illustrated in FIG. 4A. In the example of FIG. 4B, the login portion 400B of the user interface includes a patient ID section 420 and a password section 422, which may be configured to receive input from a user specifying a patient ID and a password, respectively. Patient ID section 420 and password section 422 may receive the user's input via any suitable interface components including, but not limited to, text boxes.

Returning to FIG. 3, communication management component 302 of care coordination component 160 may be configured to interact with communication information component 130 to send information to, or receive information from, a computing device 206 associated with a patient.

In some embodiments, communication management component 302 may be configured to receive data transmitted by a computing device 206 associated with a patient. The received data may include, but is not limited to, tracking data. In some embodiments, tracking data may include, but is not limited to, one or more of the patient's patient identifier, the patient's location, the patient's proximity to a healthcare facility, a healthcare facility identifier (e.g., the healthcare facility ID of the healthcare facility to which the patient's proximity satisfies one or more care coordination criteria), whether a care coordination criterion has been satisfied, which care coordination criterion has been satisfied, or any other suitable information. In some embodiments, the tracking data or portions of the tracking data may be encoded and/or encrypted.

Embodiments of PM system 100 may receive tracking data periodically and/or in response to transmitting a request for tracking data to the computing device 206 associated with the patient. In some embodiments, the frequency with which the PM system receives tracking data may depend on the rate at which the patient's location is changing (i.e., the patient's speed) or the patient's proximity to a healthcare facility. For example, when the patient's speed exceeds a threshold speed, the PM system may receive tracking data at a first frequency, and when the patient's speed is lower than the threshold speed, the PM system may receive tracking data at a second, lower, frequency. As another example, when the patient's proximity to a healthcare facility is determined to be less than a threshold proximity, the PM system may receive tracking data at a first frequency, and when the patient's proximity to all monitored healthcare facilities is determined be greater than the threshold proximity, the PM system may receive tracking data at a second, lower, frequency. The PM system may use the patient ID included in the tracking data to identify the patient to which the tracking data pertains.

In some embodiments, communication management component 302 may be configured to send locations of healthcare facilities to a computing device 206 associated with a patient. As discussed above, during enrollment the patient may authorize the PM system to facilitate coordination of care for the patient based, at least in part, on the patient's proximity to identified healthcare facilities and/or types of healthcare facilities. As further discussed above, the computing device 206 may determine proximities between the patient's location and the locations of these healthcare facilities. For this reason, PM system 100 may send locations of the specified healthcare facilities, and/or locations of healthcare facilities of the specified type(s), to a computing device 206 associated with the patient. In some embodiments, practice management system 100 may transmit the healthcare facility locations to the computing device 206 associated with the patient periodically, in response to receiving a request for updated facility locations from computing device 206, or in response to receiving an indication that the patient's location has changed from computing device 206.

In some embodiments, PM system 100 may limit the number of healthcare facility locations transmitted to the computing device 206 of a patient. For example, PM system 100 may transmit the locations of a threshold number of healthcare facilities of the specified type(s) that are closest in proximity to the patient's last known location. As another example, the PM system 100 may transmit the locations of healthcare facilities of the specified type(s) that are within a monitoring region associated with the patient. In some embodiments, the monitoring region may be a country, state, city, county, metropolitan area, or any other geographical region (such as a region of specified shape and/or area). In some embodiments, the monitoring region may encompass the patient's place of residence, place of work, or most recently transmitted location. Limiting the number of healthcare facility locations transmitted to computing device 206 may reduce the data processing and/or data storage demands on computing device 206, thereby preserving the device's battery life and storage space for other applications.

In some embodiments, PM system 100 may store locations of healthcare facilities. For example, PM system 100 may store the locations of all healthcare facilities in a region, such as a country, state, city, county, metropolitan area, or any other geographical region. As another example, PM system 100 may store the locations of all healthcare facilities encompassed within a monitoring region associated with a patient who has authorized monitoring of the patient's proximity to the facility.

In some embodiments, communication management component 302 may be configured to interact with a component of PM system 100 (e.g., a scheduling component) to obtain a patient's appointment information (e.g., information indicating a scheduled time and place of a patient's appointment with a healthcare provider). Communication management component may be configured to send such appointment information to the computing device 206 associated with a patient. The computing device 206 may use such appointment information, for example, to determine whether the patient has missed or is late for an appointment.

For many patients, the privacy and security of data relating to their location and/or health are important considerations. In some embodiments, care coordination component 160 includes a security management component 304, which may be configured to prevent or impede unauthorized access to a patient's tracking data and health information. For example, security management component 304 may be configured to prevent or impede unauthorized access to a patient's data by encrypting the data, by storing portions of the patient's data in an encoded form, by deleting (e.g., permanently deleting) some of the patient's data, or by changing the patient ID associated with a patient.

In some embodiments, security management component 304 may encrypt a patient's data including, but not limited to, a patient's health information and/or tracking data. Security management component 304 may encrypt a patient's data using any suitable encryption scheme including, but not limited to, a symmetric-key encryption scheme or a public-key encryption scheme. In some embodiments, an encryption key used by security management component 304 may be 16 bits, 32 bits, 64 bits, 128 bits, 168 bits, 256 bits, 512 bits, 1024 bits, 2048 bits, or 3072 bits long. Practice management system 100 may store the patient's data in its encrypted form, thereby preventing or impeding access to the patient's data by parties that gain unauthorized access to data stored on PM system 100. Likewise, PM system 100 may transmit the patient's data (e.g., to a computing device 206 of a patient, or to a computing device a healthcare provider) in its encrypted form, thereby preventing or impeding access to the patient's data by unauthorized parties that intercept the patient's data in transit.

In some embodiments, security management component 304 may decrypt a patient's encrypted data including, but not limited to, a patient's encrypted health information and/or tracking data. As described above, PM system 100 may store the patient's data in an encrypted form. Additionally, data received by PM system 100 (e.g., from a computing device 206 associated with a patient and/or through a user interface of PM system 100) may be encrypted. In some embodiments, security management component 304 may delete (e.g., permanently delete) a patient's decrypted data after using it, so that the patient's data is only stored on PM system 100 in its decrypted form for brief periods of time when authorized access to the decrypted data is needed.

In some embodiments, security management component 304 may be configured to decode the tracking data received from a computing device 206 of a patient. To impede unauthorized access to a patient's tracking data, computing device 206 may encode at least some portions of a patient's tracking data before encrypting and/or transmitting the tracking data to PM system 100. For example, computing device 206 may encode the portion of the tracking data that represents a patient's location using any suitable encoding scheme, including but not limited to character-based encoding, hex encoding, or base 64 encoding. In some embodiments, security management component 304 may delete (e.g., permanently delete) a patient's decoded data after using it, so that the patient's data is only stored on PM system 100 in its decoded form for brief periods of time when authorized access to the decoded data is needed.

In some embodiments, security management component 304 may delete (e.g., permanently delete) tracking data received from a computing device 206 of a patient. Security management component 304 may use any suitable technique to determine when to delete (e.g., permanently delete) one or more units of a patient's tracking data. For example, security management component 304 may delete (e.g., permanently delete) some or all of a patient's tracking data periodically or in response to receiving a transmission from computing device 206 requesting destruction of the patient's tracking data. In some embodiments, security management component 304 may delete (e.g., permanently delete) a patient's older tracking data after PM system 100 receives a specified amount of newer tracking data from the computing device 206 associated with the patient. For example, security management component 304 may be configured to delete (e.g., permanently delete) all of a patient's tracking data other than the most recent N units of tracking data, where N is an integer such as 1, 2, 5, or 10.

In some embodiments, security management component 304 may be configured to change the patient ID associated with a patient. As described above, when PM system 100 sends data to or receives data from a computing device 206 associated with a patient, the data may include the patient's patient ID, which may be used to identify the patient to whom the data pertains. Even when the patient's location data is encrypted and/or encoded, it may be intercepted, decrypted, and decoded by unauthorized parties. By assigning the patient a new patient ID, security management component 304 may protect a patient's privacy by making it difficult to associate intercepted patient data with the corresponding patient. Embodiments of security management component 304 may determine when to change a patient's patient ID using any suitable technique including, but not limited to, changing the patient ID periodically; changing the patient ID in response to receiving a request for a new patient ID from a computing device 206 associated with the patient; or changing the patient ID in response to the cumulative reception and/or transmission, since the most recent transmission of a new patient ID to the patient, of an amount of data pertaining to the patient that exceeds a threshold amount. Embodiments of security management component 304 may interact with communication management component 302 to send a patient's new patient ID to a computing device 206 associated with the patient. In some embodiments, the same patient IDs may be assigned to different patients at different times, to further frustrate efforts of unauthorized parties to correlate patient data with the identity of the corresponding patient.

In some embodiments, care coordination component 160 includes a proximity management component 306, which may be configured to determine whether the patient's proximity to a healthcare facility satisfies one or more care coordination criteria. In some embodiments, determining whether the patient's proximity to a healthcare facility satisfies one or more care coordination criteria includes determining the patient's proximity to a healthcare facility. As described above, a patient's proximity to a healthcare facility may be determined in any suitable way. For example, when the tracking data received from a computing device 206 associated with a patient includes the patient's location but not the patient's proximity to a healthcare facility, proximity management component 306 may determine the patient's proximity to one or more healthcare facilities based, at least in part, on the patient's location (e.g., using one or more of the techniques described above). As another example, when the tracking data received from a computing device 206 associated with a patient includes the patient's proximity to one or more healthcare facilities, proximity management component 306 may determine the patient's proximity to the one or more healthcare facilities by processing the tracking data.

In some embodiments, determining whether the patient's proximity to a healthcare facility satisfies one or more care coordination criteria includes determining value(s) of one or more care coordination criteria based, at least in part, on the patient's proximity to one or more healthcare facilities. Some examples of suitable care coordination criteria are described above. In some embodiments, proximity management component 306 may combine one or more care coordination criteria to form a more complex care coordination criterion. In some embodiments, proximity management component 306 may be configured to determine values of different care coordination criteria for different healthcare facilities. For example, proximity management component 306 may determine value(s) of a first set of care coordination criteria for healthcare facilities where urgent care or emergency care is administered (e.g., a set of care coordination criteria that trigger facilitation of care coordination when the patient's proximity to the facility is less than a threshold proximity). As another example, proximity management component 306 may determine value(s) of a second set of care coordination criteria for healthcare facilitates where the patient has an appointment scheduled (e.g., a set of care coordination criteria that trigger facilitation of care coordination when the patient's proximity to the facility is greater than a threshold proximity at a scheduled time of the appointment or during a specified period prior to the scheduled time of the appointment).

In some embodiments, the tracking data received from a computing device 206 associated with a patient may include data identifying one or more healthcare facilities and one or more care coordination criteria satisfied by the patient's proximity to the one or more healthcare facilities, as determined by a computing device 206 associated with the patient. In such embodiments, proximity management component 306 may determine whether the patient's proximity to a healthcare facility satisfies one or more care coordination criteria by processing the tracking data received from computing device 206.

In some embodiments, proximity management component 306 may be configured to suppress false positive determinations that a patient's proximity to a healthcare facility satisfies a care coordination criterion. A false positive determination may occur when a patient passes near a healthcare facility (e.g., walks or drives past the healthcare facility) without entering the healthcare facility for medical treatment. To suppress false positive determinations, some embodiments of proximity management component 306 may determine that the patient's proximity to a healthcare facility satisfies a care coordination criterion if M consecutive transmissions of tracking data received from a computing device 206 associated with the patient indicate that the patient's proximity to a healthcare facility satisfies a care coordination criterion, where M is an integer such as 2, 5, or 10.

Basing a determination of whether a patient's proximity to a healthcare facility satisfies a care coordination criterion on receipt of a certain number of consecutive transmissions of suitable tracking data may have drawbacks in some circumstances. In some healthcare facilities, a computing device 206 associated with a patient may have difficulty communicating with a network 210 connected to practice management system 100, due to the difficulty of transmitting signals of certain frequencies through some structures. Thus, in some cases, after a patient enters a healthcare facility, practice management system 100 may not receive further transmissions from the computing device 206 associated with the patient until the patient exits the healthcare facility. Thus, in embodiments where proximity management component 306 facilitates coordination of care for a patient only after receiving a certain number of consecutive transmissions of tracking data indicating that the patient's proximity to a healthcare facility satisfies a care coordination criterion, practice management system 100 may fail to facilitate coordination of care when a patient approaches and enters a healthcare facility before the computing device 206 associated with the patient sends the requisite number of tracking data transmissions because the computing device 206 has lost contact with network 210.

To suppress false positive determinations without also suppressing true positives, some embodiments of proximity management component 306 may be configured to determine that a patient's proximity to a healthcare facility satisfies one or more care coordination criteria if all tracking data received from the computing device 206 associated with the patient during a period of time exceeding a threshold time period indicates that the patient's proximity to the healthcare facility satisfies one or more care coordination criteria. Suitable threshold time periods may include, but are not limited to, 15 seconds, 20 seconds, 30 seconds, 1 minute, 2 minutes, or 5 minutes. Accordingly, failure of the computing device 206 to continue transmitting tracking data after the patient enters the healthcare facility may not interfere with a determination by the practice management system's of whether the patient's proximity to the healthcare facility satisfies a care coordination criterion, provided that the last transmission of tracking data made by computing device 206 prior to entering the healthcare facility indicates that the patient's proximity to the healthcare facility satisfies the criterion.

In some embodiments, communication management component 302 may be configured to transmit care coordination data to one or more healthcare providers associated with the patient when the PM system determines that a care coordination criterion has been satisfied. Some types of care coordination data that may be transmitted and techniques for transmitting care coordination data to a healthcare provider are described above. The set of healthcare providers associated with the patient may include healthcare providers identified by the patient (e.g., during enrollment), healthcare providers associated with a healthcare facility (e.g., the healthcare facility to which the patient's proximity satisfies a care coordination criterion), and/or any other healthcare provider that might reasonably facilitate coordination of care for the patient (e.g., a healthcare provider that has recently treated the patient, even if the healthcare provider was not identified by the patient during enrollment).

Implementations of communication management component 302 may select the one or more healthcare providers to which care coordination data is transmitted using any suitable technique. In some embodiments, PM system 100 may rank the healthcare providers associated with the patient according to any suitable ranking criteria (e.g., an estimate of the benefit likely to be obtained by the healthcare provider's participation in coordination of care for the patient), and transmit the care coordination data to one or more healthcare providers having the highest rankings. In some embodiments, the PM system 100 may transmit care coordination data to all healthcare providers associated with the patient. Contact information for the healthcare providers associated with the patient may be stored in PM system 100 (e.g., in health information component 110, in communication information component 130, or in communication management component 302).

Embodiments of a Computing Device Associated with a Patient

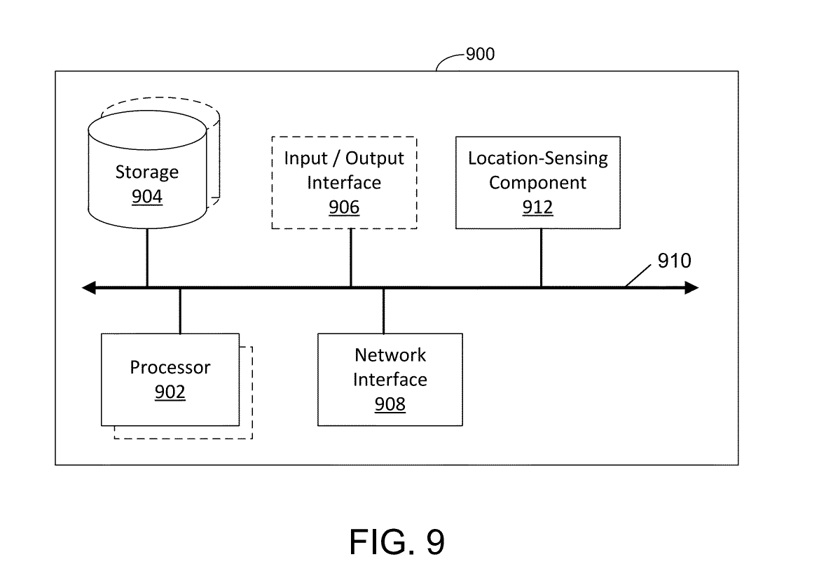

FIG. 9 illustrates a computing device 900, according to some embodiments. In some embodiments, a computing device 206 associated with a patient may be implemented as computing device 900. The computing device 900 of FIG. 9 includes one or more processors 902 and one or more storage devices 904. The one or more processors 902 may include any suitable processing device including, but not limited to, a central processing unit, a graphics processing unit, a signal processor, a microcontroller, a multicore processor, a many-core processor, a field-programmable gate array (FPGA), etc. The one or more storage devices 904 may include any suitable storage device including, but not limited to, a random-access memory (RAM) (e.g., static RAM, dynamic RAM, synchronous dynamic RAM) a read-only memory (ROM) (e.g., programmable ROM, electrically programmable ROM, electrically erasable programmable ROM, disc-based memory, solid-state memory, etc.).

Computing device 900 further includes a network interface 908, which may be configured to send and receive data over a network, such as network 210. In some embodiments, computing device 900 may include an input/output interface 906, which may be configured to receive inputs (e.g., through a keyboard, keypad, touchscreen, mouse, microphone, or any other suitable input device) to the computing device and to send outputs (e.g., through a display, a printer, a speaker, or any other suitable output device) from the computing device 900.

Computing device 900 further includes a location-sensing component 912, which may be configured to determine the location of computing device 900. Location-sensing component 912 may be configured to use any suitable technique to determine the location of computing device 900 including, but not limited to, performing triangulation, trilateration, or multi-lateration based on signals transmitted by satellites, mobile phone towers, wireless access points, or other suitable signal transmitters. In some embodiments, location-sensing component 912 may include a receiver, such as GPS receiver or a GNSS receiver, that communicates with a satellite-based positioning system, such as the global positioning system (GPS) or the global navigation satellite system (GNSS), to determine the location of the computing device. When computing device 900 is near a patient, the location of location-sensing component 912 may be considered an estimate of or proxy for the location of the patient.

One or more storage devices 904 may store instructions which, when executed by processor(s) 902, cause the computing device 900 to facilitate coordination of care for a patient associated with the computing device. The instructions may correspond to a software application (e.g., a mobile “app”) downloaded by computing device 900 as part of a process of enrolling a patient in an automated care coordination program.

In some embodiments, computing device 900 may facilitate coordination of care for a patient by receiving one or more patient identifiers (patient IDs) assigned to a patient. In some embodiments, a patient ID may uniquely identify the patient, and the patient ID may be temporarily or permanently assigned to the patient. In some embodiments, computing device 900 may receive one or more patient IDs periodically or in response to transmission of a patient ID by a practice management system.

The patient ID may be formatted as a number, character string (e.g., alphabetical character string, numeric character string, alphanumeric character string, or any other suitable type of character string such as a character string which includes non-alphanumeric symbols), or in any other suitable way. The patient ID may be received via input/output interface 906, via network interface 908, or in any other suitable way. In some embodiments, the patient ID may be received by scanning an image (e.g., a bar code or quick response code) using a scanner, bar code reader, camera, or other suitable input device associated with input/output interface 906. In some embodiments, the patient ID may be entered using a keyboard, keypad, or touchscreen associated with input/output interface 906.

In some embodiments, computing device 900 may facilitate coordination of care for a patient by receiving and storing healthcare facility data. In some embodiments, the healthcare facility data may include location(s) of one or more healthcare facilities associated with the patient by a practice management system. In some embodiments, the one or more healthcare facilities may be facilities specified by the patient, a healthcare provider associated with the patient, or any other suitable user through a user interface of the practice management system. In some embodiments, the one or more healthcare facilities may be facilities of one or more types specified by a user through a user interface of the practice management system.

In some embodiments, the healthcare facility data may include one or more facility identifiers (facility IDs) corresponding to the one or more healthcare facilities. A facility ID may uniquely identify a healthcare facility. A facility ID may be formatted as a number, as a character string (e.g., an alphabetical character string, a numeric character string, an alphanumeric character string, or any other suitable type of character string such as a character string which includes non-alphanumeric symbols), or in any other suitable way. The facility ID may be received via network interface 908, or in any other suitable way. In some embodiments, the facility ID may be transmitted by a practice management system.

In some embodiments, computing device 900 may receive updated healthcare facility data periodically (e.g., once per day, once per week, or once per month), in response to transmitting a request for healthcare facility data, in response to a practice management system transmitting healthcare facility data, or in any other suitable way. In some embodiments, computing device 900 may request updated healthcare facility data periodically (e.g., once per day, once per week, or once per month), in response to determining that the location of computing device 900 has changed by more than a threshold distance since the last time updated healthcare facility data was received, or in response to detecting any other suitable condition.

In some embodiments, computing device 900 may facilitate coordination of care for a patient by determining whether the patient's proximity to a healthcare facility satisfies a care coordination criterion. Illustrative techniques for determining whether a patient's proximity to healthcare facility satisfies a care coordination criterion, based (at least in part) on the patient's location and/or the location of the healthcare facility, are described above. In some embodiments, determining whether a patient's proximity to a healthcare facility satisfies a care coordination criterion may include determining the patient's location (e.g., with location-sensing component 912), determining the patient's proximity to one or more healthcare facilities (e.g., based on the patient's location and the location(s) of the one or more healthcare facilities), and determining value(s) of one or more care coordination criteria.

In some embodiments, after determining that the patient's proximity to a healthcare facility satisfies one or more care coordination criteria, computing device 900 may transmit tracking data to a practice management system 100. In some embodiments, computing device 900 may transmit the tracking data using network interface 908 (e.g., by sending a text message, short message service (SMS) message, or user datagram protocol (UDP) packet). In some embodiments, the transmitted tracking data may include the patient ID assigned to the patient associated with computing device 900, and the facility ID of the healthcare facility to which the patient's proximity satisfies a care coordination criterion. In response to receiving the tracking data, embodiments of practice management system 100 may facilitate coordination of care for the patient (e.g., by sending care coordination data to a healthcare provider associated with the patient). Even if the tracking data is intercepted by an unauthorized party, the tracking data may identify the patient only by the patient ID, and may identify the healthcare facility only by the facility ID. Thus, in some embodiments, a risk of an unauthorized party using intercepted tracking data to determine the patient's past and/or current locations is reduced compared to if such tracking data was transmitted without using assigned identifiers for the patient and/or the facility.

In some embodiments, computing device 900 may facilitate coordination of care for a patient by determining the patient's proximity to a healthcare facility. Illustrative techniques for determining a patient's proximity to a healthcare facility based, at least in part, on the patient's location and the location of the healthcare facility, are described above. In some embodiments, after determining the patient's proximity to a healthcare facility, computing device 900 may transmit tracking data to a practice management system 100. The transmitted tracking data may include the patient ID assigned to the patient associated with computing device 900, the facility ID of the healthcare facility to which the patient's proximity satisfies a care coordination criterion, and the proximity of the patient to the healthcare facility. In response to receiving the tracking data, embodiments of practice management system 100 may facilitate coordination of care for the patient (e.g., by determining whether the patient's proximity to the healthcare facility satisfies one or more care coordination criteria, and if so, by sending care coordination data to a healthcare provider associated with the patient).

In some embodiments, computing device 900 may facilitate coordination of care for a patient by determining a patient's location. Illustrative techniques for determining a patient's location are described above. In some embodiments, after determining the patient's location, computing device 900 may transmit tracking data to a practice management system 100. The transmitted tracking data may include the patient ID assigned to the patient associated with computing device 900, and the location of the patient. In response to receiving the tracking data, embodiments of practice management system 100 may facilitate coordination of care for the patient (e.g., by determining whether the patient's proximity to a healthcare facility satisfies one or more care coordination criteria, and if so, by sending care coordination data to a healthcare provider associated with the patient).

In some embodiments, computing device 900 may be a mobile computing device configured to operate on battery power. To facilitate the conservation of energy (and thereby extend the device's battery life), some embodiments of computing device 900 may be configured to use any suitable techniques including, but not limited to, deactivating location-sensing component 912 after determining a location of a patient associated with computing device 900, or reducing the frequency with which the location of the patient is determined when the patient is unlikely to be approaching a healthcare facility.

In some embodiments, computing device 900 may be configured to determine the location of the patient at a first frequency when the most recent location determined by location-sensing component 912 is within a threshold distance of the previous location determined by location-sensing component 912. Computing device 900 may further be configured to determine the location of the patient at a second, higher frequency when the most recently determined location is not within the threshold distance of the previously determined location. In some embodiments, the first frequency may be four times per hour, the second frequency may be one time per minute, and the threshold distance may be 100 feet. In some embodiments, computing device 900 may transition from the second frequency to the first frequency after location-sensing component 912 determines K consecutive locations of the patient, and the K consecutive locations are all within a threshold distance of each other or of some other location. In some embodiments, K may be an integer greater than one (e.g., five) and the threshold distance may be 100 feet.

To avoid sending tracking data to practice management system 100 when the patient is merely traveling near a healthcare facility (rather than visiting the healthcare facility), computing device 900 may, in some embodiments, transmit tracking data to practice management system 100 only after determining that L consecutive locations of the patient, as determined by location-sensing component 912, are within a threshold proximity of a healthcare facility. In some embodiments, L may be an integer greater than or equal to one (e.g., three), and the threshold proximity may be 100 feet.

To protect the privacy of a patient's current and past locations, in some embodiments, computing device 900 secures the patient's current and past location data using any suitable technique including, but not limited to, encoding the location data, encrypting the location data, or deleting the location data after it becomes outdated (e.g., after sending tracking data to practice management system 100, or after obtaining more than a threshold number of more recent determinations of the patient's location).

Embodiments of a Process of Facilitating Coordination of Care

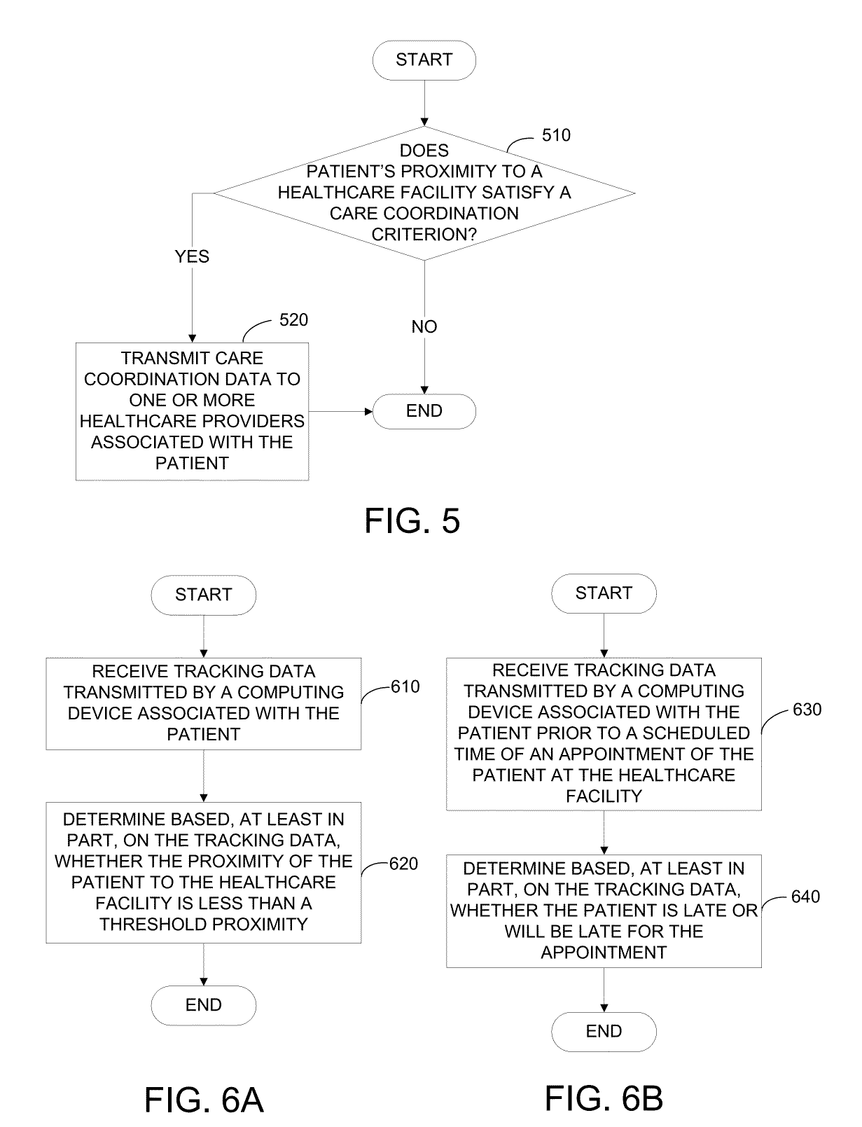

FIG. 5 illustrates a process for transmitting care coordination data to a healthcare provider associated with a patient based, at least in part, on a proximity of the patient to a healthcare facility, in accordance with some embodiments. Act 510 of the illustrated process includes determining whether a patient's proximity to one or more healthcare facilities satisfies one or more coordination criteria. Illustrative techniques for determining whether a patient's proximity to a healthcare facility satisfies one or more coordination criteria are described above. In some embodiments, this determination may be made by a practice management system, by a computing device associated with a patient, or by a combination of a practice management system and a computing device associated with a patient. In some embodiments, act 510 may include determining whether a patient's proximity to a first healthcare facility satisfies a first care coordination criterion, and determining whether a patient's proximity to a second healthcare facility satisfies a second care coordination criterion. Illustrative care coordination criteria are described above.

If it is determined that the proximity of the patient to a healthcare facility satisfies one or more care coordination criteria, the process proceeds to act 520, where care coordination data is transmitted to one or more healthcare providers associated with the patient. Illustrative care coordination data are described above. Non-limiting techniques for selecting one or more healthcare providers associated with the patient and transmitting care coordination data to the selected healthcare providers are described above. In some embodiments, the transmission of care coordination data may be performed by a practice management system. In some embodiments, the transmission of care coordination data may be performed by a computing device associated with the patient, or the transmission of care coordination data may be performed by a combination of a practice management system and a computing device associated with the patient.

The process illustrated in FIG. 5 may be performed by a practice management system at any time including, but not limited to, in response to receiving tracking data from a computing device associated with a patient, in response to receiving a request to facilitate care coordination from a computing device associated with a patient, after passage of a specified period of time, etc. Additionally, the process illustrated in FIG. 5 may be performed by a computing device associated with a patient at any time including, but not limited to, in response to obtaining an updated determination of the patient's location, in response to receiving a query to facilitate care coordination from a practice management system, after passage of a specified period of time, etc.

FIG. 6A illustrates a process for determining whether the proximity of a patient to a healthcare facility satisfies one or more care coordination criteria, in accordance with some embodiments. In act 610, tracking data transmitted by a computing device associated with a patient is received. Illustrative tracking data are described above. Some or all of the tracking data may be encrypted and/or encoded. In some embodiments, the process illustrated in FIG. 6A may also include an act (not shown) of decrypting and/or decoding at least a portion of the tracking data. For example, some tracking data may include a location of a patient, which may be encrypted and/or encoded, and the process of FIG. 6A may include an act (not shown) of decrypting and/or decoding the location of the patient. In some embodiments, the tracking data may include a patient ID, which may be used to identify the patient to which the tracking data pertains.

In some embodiments, receiving the tracking data comprises receiving first and second tracking data transmitted by a computing device associated with the patient. The first tracking data may include a first location of the patient at a first time, and the second tracking data may include a second location of the patient at a second time. In some embodiments, a duration of a time period between the second time and the first time may depend on a speed of a patient and/or a proximity of the patient to a healthcare facility. For example, the computing device associated with the patient may transmit tracking data less frequently when the patient is moving slowly (or not at all), or when the patient is not near a healthcare facility.

After receiving the tracking data, the process proceeds to act 620, where it is determined (based, at least in part, on the tracking data), whether the proximity of the patient to the healthcare facility is less than a threshold proximity. Illustrative techniques for determining whether the proximity of the patient to a healthcare facility is less than a threshold proximity are described above. In some embodiments, the tracking data received in act 610 may include a location of the patient, and determining whether the proximity of the patient to the healthcare facility is less than a threshold proximity may include comparing the location of the patient to a location of the healthcare facility. The location of the healthcare facility may be stored, for example, by a practice management system. In some embodiments, the tracking data received in act 610 may include a location of the patient, and determining whether the proximity of the patient to the healthcare facility is less than a threshold proximity may include determining a distance between the location of the patient and a location of the healthcare facility. Illustrative techniques for determining a distance between two locations are described above. In some embodiments, the tracking data received in act 610 may include a proximity of the patient to the healthcare facility, and determining whether the proximity of the patient to the healthcare facility is less than a threshold proximity may include comparing the proximity included in the tracking data to the threshold proximity. In some embodiments, a care coordination criterion may be satisfied if it is determined that the patient's proximity to a healthcare facility is less than the threshold proximity.

FIG. 6B illustrates another process for determining whether the proximity of a patient to a healthcare facility satisfies one or more care coordination criteria, in accordance with some embodiments. In act 630, tracking data transmitted by a computing device associated with a patient is received at a time prior to a scheduled time of an appointment of the patient at the healthcare facility. As described above, practice management system 100 may store information relating to a patient's scheduled appointments (e.g., times and locations of the patient's scheduled appointments). In some embodiments, the tracking data may include a location of the patient. In some embodiments, the tracking data may also include a time at which the patient was determined to be at the location included in the tracking data.

After receiving the tracking data, the process proceeds to act 640, where it is determined (based, at least in part, on the tracking data), whether the patient is late or is likely to be late for an appointment. Illustrative techniques for determining whether a patient is late for or has missed an appointment are described above. Illustrative techniques for predicting whether a patient is likely to be late for or is likely to miss an appointment are described above. In some embodiments, predicting whether a patient is likely to be late for or is likely to miss an appointment may depend on a time of the appointment and/or a time at which the patient was determined to be at a location. In some embodiments, a care coordination criterion may be satisfied if it is determined that the patient is late or is likely to be late for an appointment.

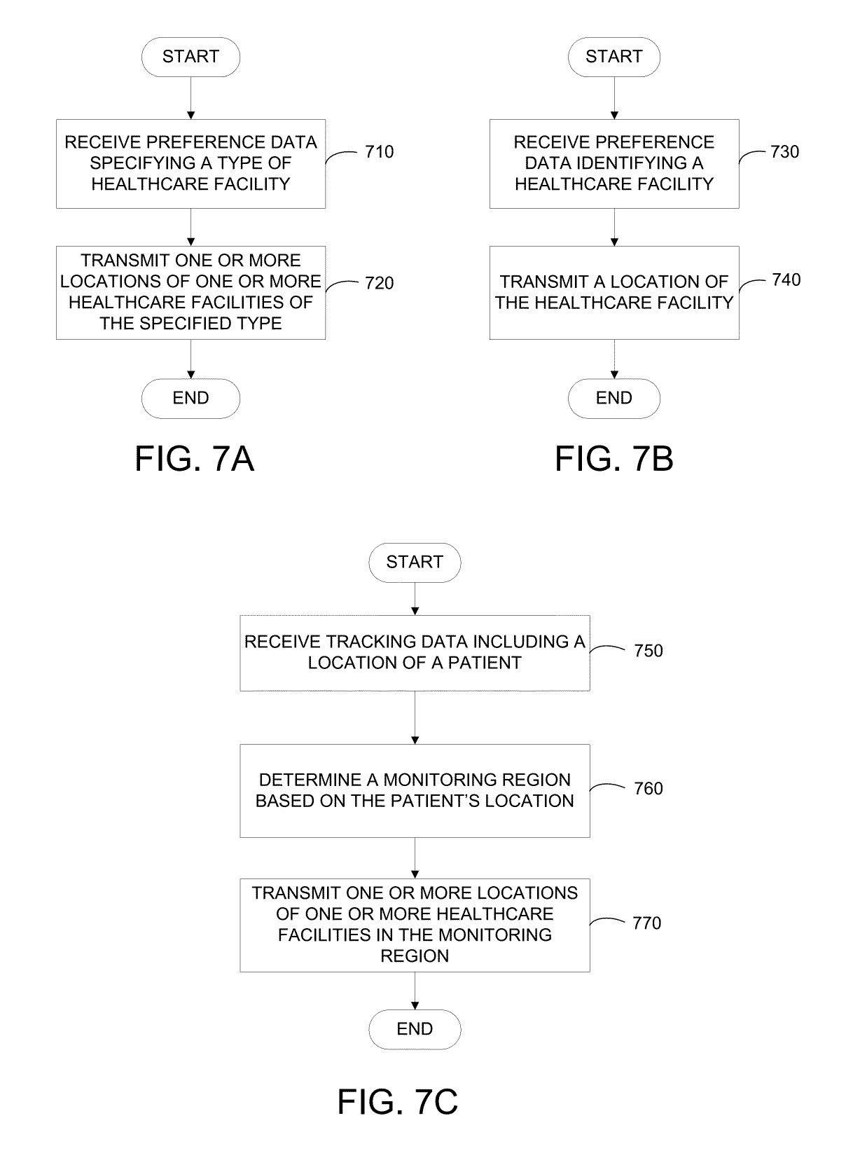

FIG. 7A illustrates a process for transmitting a location of a healthcare facility to a computing device associated with a patient, in accordance with some embodiments. In act 710, preference data specifying one or more types of healthcare facilities is received. Illustrative techniques for receiving preference data specified by a patient and/or a patient's healthcare provider are described above. In some embodiments, the preference data is received through a user interface of a practice management system. Non-limiting types of healthcare facilities are described above.

After receiving preference data, the process proceeds to act 720, where one or more locations of one or more healthcare facilities of the type specified in the preference data are transmitted. In some embodiments, the one or more locations may be transmitted to a computing device associated with a patient. Information regarding healthcare facilities including, but not limited to, types and/or locations of healthcare facilities, may be stored by a practice management system. Illustrative techniques for selecting a subset of healthcare facilities of a specified type and transmitting the locations of that subset of healthcare facilities (e.g., the facilities within a specified geographic region) are described above.

FIG. 7B illustrates another process for transmitting a location of a healthcare facility to a computing device associated with a patient, in accordance with some embodiments. In act 730, preference data identifying one or more healthcare facilities is received. Illustrative techniques for receiving preference data specified by a patient and/or a patient's healthcare provider are described above. In some embodiments, the preference data is received through a user interface of a practice management system.

After receiving preference data, the process proceeds to act 740, where one or more locations of the one or more healthcare facilities identified in the preference data are transmitted. In some embodiments, the one or more locations may be transmitted to a computing device associated with a patient. Information regarding healthcare facilities including, but not limited to, locations of healthcare facilities, may be stored by a practice management system.

FIG. 7C illustrates yet another process for transmitting a location of a healthcare facility to a computing device associated with a patient, in accordance with some embodiments. In act 750, tracking data including a location of a patient is received. Illustrative tracking data are described above. Some or all of the tracking data (e.g., the location of the patient) may be encrypted and/or encoded. In some embodiments, the process illustrated in FIG. 7C may also include an act (not shown) of decrypting and/or decoding at least a portion of the tracking data (e.g., a portion of the tracking data that includes the patient's location). In some embodiments, the tracking data may include a patient ID, which may be used to identify the patient to which the tracking data pertains.

After receiving the tracking data, the process proceeds to act 760, where a monitoring region is determined based on the patient's location. Non-limiting examples of monitoring regions are described above. In some embodiments, determining a monitoring region may include selecting a region that corresponds to a country, state, city, county, or metropolitan area which encompasses a location associated with the patient, such as the location of the patient's residence, the location of the patient's workplace, or the location included in the tracking data. In some embodiments, determining a monitoring region may include identifying a region of a specified shape and size that encompasses a location associated with the patient (e.g., a circular region with a specified radius, a rectangular region with specified length and width, etc.). In some embodiments, determining a monitoring region may include identifying a region that encompasses a location associated with the patient and a specified number of city blocks. A monitoring region may be determined using any suitable techniques, including, but not limited to, the techniques described above.

After determining a monitoring region, the process proceeds to act 770, where one or more locations of one or more healthcare facilities encompassed within the monitoring region are transmitted (e.g., to a computing device associated with the patient). Any suitable techniques may be used to identify healthcare facilities encompassed within a monitoring region. In some embodiments, the healthcare facilities encompassed within a monitoring region may be identified by querying a mapping service, or by comparing locations of healthcare facilities to locations included in the monitoring region.

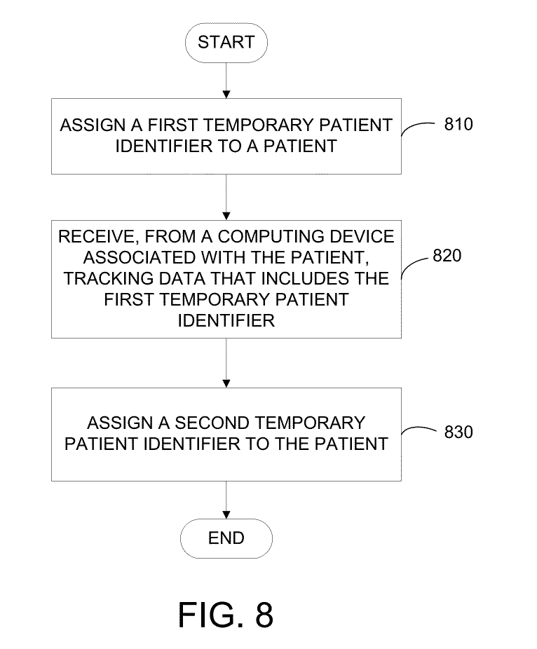

FIG. 8 illustrates a process for assigning temporary patient identifiers to a patient, in accordance with some embodiments. In act 810 of the process illustrated in FIG. 8, a first temporary patient identifier is assigned to a patient. Illustrative techniques for assigning a temporary patient identifier to a patient are described above. In some embodiments, the temporary patient identifier may uniquely identify the patient to whom the temporary patient ID is assigned during the period in which the temporary patient ID is assigned to the patient. In some embodiments, the temporary patient identifier may be represented, for example, by a character string. In some embodiments, assigning the first temporary patient ID may include transmitting the first temporary patient ID to a computing device associated with the patient.

After assigning the first patient identifier, the process proceeds to act 820, where tracking data that includes the first temporary patient identifier is received from a computing device associated with the patient. As described above, the first temporary patient identifier may be used to identify the patient to whom the tracking data pertains.

After receiving the tracking data (or at any other suitable time), the process proceeds to act 830, where a second temporary patient identifier is assigned to a patient. Illustrative techniques for assigning a temporary patient identifier to a patient are described above. In some embodiments, assigning the second temporary patient ID may include transmitting the second temporary patient ID to a computing device associated with the patient. In some embodiments, assigning the second temporary patient ID may include terminating the association between the patient and the first temporary patient ID.

### OTHER EMBODIMENTS

The foregoing paragraphs refer to data “including” or “comprising” information. Where data is said to include or comprise information, one of ordinary skill in the art would understand that the data and/or information may be encoded and/or encrypted, such that access to the information may be obtained by decoding and/or decryption.

The above-described embodiments may be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the techniques described herein comprises at least one non-transitory computer-readable storage medium (e.g., a computer memory, a USB drive, a flash memory, a compact disk, a tape, etc.) encoded with a computer program (i.e., a plurality of instructions), which, when executed on a processor, performs the above-discussed functions. The computer-readable storage medium can be transportable such that the program stored thereon can be loaded onto any computer resource to implement the aspects of the techniques discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the techniques described herein.

Various techniques described herein may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments may be implemented as one or more processes, of which an example has been provided. The acts performed as part of the process(es) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments in detail, various modifications and improvements will readily occur to those skilled in the art. Such modifications and improvements are intended to be within the spirit and scope of the disclosure. Accordingly, the foregoing description is by way of example only, and is not intended as limiting.

What is claimed is:

1. A method of transmitting care coordination data to a healthcare provider associated with a patient based, at least in part, on a proximity of the patient to a healthcare facility, the method comprising:
determining, with at least one processor, whether the proximity of the patient to the healthcare facility satisfies a criterion; and
after it is determined that the proximity of the patient to the healthcare facility satisfies the criterion, transmitting the care coordination data to the healthcare provider associated with the patient.

2. The method of claim 1, wherein determining whether the proximity of the patient to the healthcare facility satisfies the criterion comprises:
receiving tracking data from a computing device associated with the patient; and
determining based, at least in part, on the tracking data, whether the proximity of the patient to the healthcare facility is less than a threshold proximity,
wherein the criterion is satisfied when it is determined that the proximity of the patient to the healthcare facility is less than the threshold proximity.

3. The method of claim 2, wherein the tracking data includes a location of the patient, and wherein determining whether the proximity of the patient to the healthcare facility is less than the threshold proximity comprises comparing the location of the patient to a location of the healthcare facility.

4. The method of claim 2, wherein the tracking data includes a location of the patient, and wherein determining whether the proximity of the patient to the healthcare facility is less than the threshold proximity comprises determining a distance between the location of the patient and a location of the healthcare facility.

5. The method of claim 2, wherein the tracking data includes the proximity of the patient to the healthcare facility, and wherein determining whether the proximity of the patient to the healthcare facility is less than the threshold proximity comprises comparing the proximity included in the tracking data to the threshold proximity.

6. The method of claim 1, wherein determining whether the proximity of the patient to the healthcare facility satisfies the criterion comprises:
receiving tracking data from a computing device associated with the patient prior to a scheduled time of an appointment of the patient at the healthcare facility; and
determining based, at least in part, on the tracking data, whether the patient is late or is likely to be late for the appointment,
wherein the criterion is satisfied when it is determined that the patient is late or is likely to be late for the appointment.

7. The method of claim 6, wherein determining whether the patient is late or is likely to be late for the appointment is further based, at least in part, on a time associated with the tracking data.

8. The method of claim 1, further comprising:
receiving, through a user interface of the practice management system, preference data specifying a type of healthcare facility;
transmitting, to a computing device associated with the patient, a location of one or more healthcare facilities of the specified type, the one or more healthcare facilities of the specified type including the healthcare facility.

9. The method of claim 1, further comprising:
receiving, through a user interface of the practice management system, preference data identifying the healthcare facility;
transmitting, to a computing device associated with the patient, a location of the healthcare facility.

10. The method of claim 1, further comprising:
receiving, from a computing device associated with the patient, tracking data including a location of the patient;
determining a geographical area based, at least in part, on the location of the patient;
transmitting, to the computing device associated with the patient, a location of one or more healthcare facilities in the geographical area, the one or more healthcare facilities in the geographical area including the healthcare facility.

11. The method of claim 1, further comprising:
assigning a first temporary patient identifier to the patient;
receiving tracking data from the computing device associated with the patient, wherein the tracking data includes the first temporary identifier; and
assigning a second temporary identifier to the patient.

12. The method of claim 2, wherein the tracking data includes tracking information selected from the group consisting of a temporary identifier of the patient, a location of the patient, and the proximity of the patient to the healthcare facility.

13. The method of claim 2, further comprising decrypting and/or decoding at least a portion of the tracking data to obtain at least a portion of the tracking information.

14. The method of claim 2, wherein the tracking data comprises first tracking data including a first location of a patient at a first time, wherein determining the proximity of the patient to the healthcare facility further comprises:
receiving second tracking data including a second location of a patient at a second time; and
determining the proximity of the patient to the healthcare facility based, at least in part, on a duration of a time period between the first time and the second time.

15. The method of claim 1, wherein the care coordination data comprises information selected from the group consisting of a name of the patient, a location of the patient, an identifier of the healthcare facility, a location of the healthcare facility, the proximity of the patient to the healthcare facility, the criterion satisfied by the proximity of the patient to the healthcare facility, contact information of the healthcare facility, health information relating to the patient, and a message regarding the patient.

16. A computer system including at least one server computer configured to host a practice management system, the practice management system comprising:
at least one processor programmed to:
determine whether a proximity of a patient to a healthcare facility satisfies a criterion; and
control a communications interface to transmit care coordination data to a healthcare provider associated with the patient, after it is determined that the proximity of the patient to the healthcare facility satisfies the criterion.

17. The computer system of claim 16, wherein the at least one processor is further programmed to determine whether the proximity of the patient to the healthcare facility satisfies the criterion by:
receiving tracking data from a computing device associated with the patient; and
determining based, at least in part, on the tracking data, whether the proximity of the patient to the healthcare facility is less than a threshold proximity,
wherein the criterion is satisfied if it is determined that the proximity of the patient to the healthcare facility is less than the threshold proximity.

18. The computer system of claim 16, wherein the at least one processor is further programmed to determine whether the proximity of the patient to the healthcare facility satisfies the criterion by:
receiving tracking data from a computing device associated with the patient prior to a scheduled time of an appointment of the patient at the healthcare facility; and
determining based, at least in part, on the tracking data, whether the patient is late or is likely to be late for the appointment,
wherein the criterion is satisfied if it is determined that the patient is late or is likely to be late for the appointment.

19. The computer system of claim 16, wherein the at least one processor is further programmed to:
receive, through a user interface, preference data specifying a type of healthcare facility; and
transmit, to a computing device associated with the patient, a location of one or more healthcare facilities of the specified type, the one or more healthcare facilities of the specified type including the healthcare facility.

20. The computer system of claim 16, wherein the at least one processor is further programmed to:
receive, from a computing device associated with the patient, tracking data including a location of the patient;
determine a geographical area based, at least in part, on the location of the patient;
transmit, to the computing device associated with the patient, a location of one or more healthcare facilities in the geographical area, the one or more healthcare facilities in the geographical area including the healthcare facility.

21. The computer system of claim 16, wherein the at least one processor is further programmed to periodically change a temporary identifier associated with the patient.

22. The computer system of claim 16, wherein the care coordination data comprises information selected from the group consisting of a name of the patient, a location of the patient, an identifier of the healthcare facility, a location of the healthcare facility, the proximity of the patient to the healthcare facility, the criterion satisfied by the proximity of the patient to the healthcare facility, contact information of the healthcare facility, health information relating to the patient, and a message regarding the patient.

23. At least one computer-readable medium encoded with a plurality of instructions that, when executed by a computer, cause the computer to perform a method of transmitting care coordination data to a healthcare provider associated with a patient based, at least in part, on a proximity of the patient to a healthcare facility, the method comprising:
determining, with at least one processor, whether the proximity of the patient to the healthcare facility satisfies a criterion; and
after it is determined that the proximity of the patient to the healthcare facility satisfies the criterion, transmitting the care coordination data to the healthcare provider associated with the patient.
